(19) United States
(12) Patent Application Publication
(10) Pub. No.: US 2017/0184870 A1
(43) Pub. Date: Jun. 29, 2017

(54) DISPLAY APPARATUS AND VEHICLE UTILIZING THE SAME

(71) Applicant: BOE TECHNOLOGY GROUP CO., LTD., Beijing (CN)

(72) Inventors: Wenbo LI, Beijing (CN); Yefei DONG, Beijing (CN); Yanbing WU, Beijing (CN)

(73) Assignee: BOE Technology Group Co., Ltd., Beijing (CN)

(21) Appl. No.: 15/325,054

(22) PCT Filed: Mar. 22, 2016
(86) PCT No.: PCT/CN2016/076982

§ 371 Date: Jan. 9, 2017

(30) Foreign Application Priority Data
Apr. 21, 2015 (CN) 201510191736.6

(51) Int. Cl. G02B 27/28; G03B 21/00; B60K 35/00; G02F 1/1335

(52) U.S. Cl. CPC G02B 27/286; G02F 1/133536; G03B 21/006; B60K 35/00; G02F 2001/133548; G02F 2203/02; B60K 2350/1072; B60K 2350/2052; B60K 2350/921

(57) ABSTRACT

This disclosure relates to the technical field of display apparatus, and in particular to a display apparatus and a vehicle utilizing the same. The display apparatus comprises a transmitting device for forming privacy images on a front windshield of a vehicle body and polarized glasses for viewing the privacy images. In the above technical solutions, privacy images are formed on the front windshield of the vehicle body by the transmitting device, such that the formed images will not interfere with the driver's driving. Meanwhile, the passengers can view the images on the front windshield by wearing the polarized glasses. By using the above transmitting device to form privacy images on the front windshield, an area of display is enlarged to facilitate the passengers' viewing. Passengers sitting in the rear portion of the vehicle can clearly view the images, and the visual effect during the passengers' viewing is improved.

### FIELD OF THE INVENTION

This disclosure relates to the technical field of display apparatus, and in particular to a display apparatus and a vehicle utilizing the same.

### BACKGROUND ART

In order to improve comfort of passengers, a display apparatus is often arranged in vehicles of the prior art so as to allow the passengers to watch video programs. However, a conventional display is usually used as the display apparatus in the prior art. For example, in a car, the display apparatus is often arranged in a position of the car on a side of the steering wheel. As there is quite little space in this position, the size of the display apparatus is restricted; for a bus, an overhead display apparatus is usually used to display images, but the display apparatus is also too small to be viewed by the passengers.

### SUMMARY

This disclosure provides a display apparatus and a vehicle utilizing the same so as to facilitate passengers' viewing of programs during a ride and improve the viewing effect.

This disclosure provides a display apparatus, comprising a transmitting device configured for forming privacy images on a front windshield of a vehicle body; and polarized glasses configured for viewing the privacy images.

In the above technical solution, privacy images are formed on the front windshield of the vehicle body by the transmitting device, such that the formed images will not interfere with the driver's driving. Meanwhile, the passengers can view the images on the front windshield by wearing the polarized glasses. By using the above transmitting device to form privacy images on the front windshield, an area of display is enlarged to facilitate the passengers' viewing such that passengers sitting in the rear portion of the vehicle can clearly view the images, which improves the visual effect during the passengers' viewing.

Optionally, the transmitting device is a transparent display device arranged on the front windshield, the transparent display device comprising a polarizer, two substrates arranged on the polarizer and aligned with each other, and a liquid crystal layer arranged between the two substrates. In this case, the privacy images are formed directly by the transparent display device.

Optionally, the transparent display device is arranged in a position of the front windshield higher than the height of seats in the vehicle, which facilitates the passengers' viewing of the images.

Optionally, the display apparatus further comprises a light source part for providing light to the transparent display device, wherein the light source part is arranged on the vehicle body. This can improve the light intensity of the displayed images.

Optionally, the light source part is arranged in a position of the vehicle body where a wiper is located, so as to avoid influence of the provided light on the driver.

Optionally, the transmitting device is a projection device arranged on the vehicle body, wherein the projection device illuminates the front windshield to form privacy images. The projection device comprises a backlight source, a polarizer arranged on the backlight source, and two substrates arranged on the polarizer and aligned with each other, wherein between the two substrates a liquid crystal layer is arranged, which helps to form privacy images by projection.

Optionally, the projection device is one capable of emitting polarized light, and the display apparatus further comprises a selectively reflective part arranged on the front windshield and capable of reflecting the polarized light emitted by the projection device. The selectively reflective part can allow transmission of light having a different polarization direction than the polarized light emitted by the projection device, thereby preventing the displayed images from being viewed from the outside of the vehicle without influencing the viewing of the inside through the window.

Optionally, the selectively reflective part is a wire grid polarizing plate or a cholesteric liquid crystal device.

Optionally, a projection region of the projection device is located in an upper middle part of the front windshield so as to facilitate the passengers' viewing.

This disclosure further provides a vehicle, the vehicle comprising a vehicle body and any of the above display apparatus arranged on the vehicle body.

In the above technical solution, privacy images are formed on the front windshield of the vehicle body by the transmitting device, such that the images formed will not interfere with the driver's driving. Meanwhile, the passengers can view the images on the front windshield by wearing the polarized glasses. By using the above transmitting device to form privacy images on the front windshield, an area of display is enlarged and the passengers' viewing is facilitated such that passengers sitting in the rear portion of the vehicle can clearly view the images, which improves the visual effect during the passengers' viewing.

### BRIEF DESCRIPTION OF DRAWINGS

FIG. 1 is a schematic structural view of a display apparatus provided in an embodiment of this disclosure;

FIG. 2 is a cross-sectional view of the display apparatus provided in an embodiment of this disclosure;

FIG. 3 is a schematic structural view of another display apparatus provided in an embodiment of this disclosure;

FIG. 4 is a schematic structural view of yet another display apparatus provided in an embodiment of this disclosure;

FIG. 5 is a schematic structural view of a selectively reflective part provided in an embodiment of this disclosure;

FIG. 6 is a schematic structural view of still another display apparatus provided in an embodiment of this disclosure; and

FIG. 7 is a schematic structural view of a selectively reflective part provided in an embodiment of this disclosure.

Reference signs: 10-front windshield; 20-transmitting device; 21-transparent display device; 211-polarizer; 212-first substrate; 213-liquid crystal layer; 214-second substrate; 22-projection device; 23-polarizing plate; 30-polarized glasses; 40-selectively reflective part; 41-wire grid polarizing plate; 42-cholesteric liquid crystal device.

### DETAILED DESCRIPTION OF EMBODIMENTS

To facilitate passengers' viewing of programs during a ride of a vehicle and improve the passengers' viewing effect, the embodiments of this disclosure provide a display apparatus and a vehicle. In the present technical solutions, privacy images are formed on the front windshield by a transmitting device, such that passengers can directly view the images on the front windshield by means of polarized glasses 30, thereby achieving a large-screen viewing effect. With privacy images, influence of the images on the driver's driving can be avoided. In order to render the objects, the technical solutions and the advantages of this disclosure clearer, this disclosure will be further explained in detail by taking the following non-restrictive embodiments as examples.

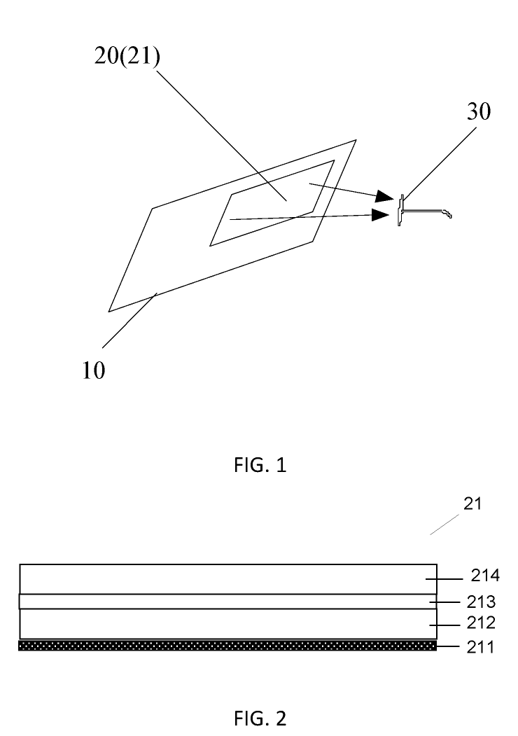

FIG. 1 is a schematic structural view of a display apparatus provided in an embodiment of this disclosure. The display apparatus comprises a transmitting device 20 for forming privacy images on a front windshield 10 of a vehicle body and polarized glasses 30 for viewing the privacy images.

With privacy images, influence of the formed images on the driver is avoided; meanwhile, the passengers' viewing effect is improved. The specific privacy images can be formed by a display apparatus having only one layer of polarizing plate such that the projected images can only be observed by wearing glasses with polarizing plates. In this embodiment, privacy images are formed on the front windshield 10 of the vehicle body by the transmitting device 20, such that the formed images will not interfere with the driver's driving; meanwhile, the passengers can view the images on the front windshield 10 by wearing the polarized glasses 30. By using the above transmitting device 20 to form privacy images on the front windshield 10, an area of display is enlarged and the passengers' viewing is facilitated such that passengers sitting in the rear portion of the vehicle can clearly view the images, which improves the visual effect during the passengers' viewing.

Different transmitting devices 20 can be adopted for forming privacy images on the front windshield 10.

As an example, as shown in FIG. 1, the transmitting device 20 is a transparent display device 21, and the transparent display device is arranged on the front windshield.

FIG. 2 is a cross-sectional view of the transparent display device 21 provided in an embodiment of this disclosure. The transparent display device 21 can comprise a polarizer 211, two substrates 212 and 214 arranged on the polarizer 211 and aligned with each other, and a liquid crystal layer 213 arranged between the two substrates.

The transparent display device 21 can be embedded into the front windshield 10 or directly integrated with the front windshield 10. The transparent display device 21 is a display panel having no backlight source and its structure is specifically shown in FIG. 2. The display panel comprises a polarizer 211, two substrates arranged on the polarizer 211 and aligned with each other. The two substrates are respectively a first substrate 212 and a second substrate 214, and a liquid crystal layer 213 is provided between the two substrates as a filling. When the transparent display device 21 operates, sunlight or lamp light from the outside illuminates the transparent display device 21 to enable the transparent display device 21 to display. The polarizer 211 turns the formed images into privacy images such that the driver cannot see the privacy images though the passengers can view them with the help of the polarized glasses 30 they wear. By virtue of the transparent display apparatus 21, large-screen display images can be formed on the front windshield 10 and the passengers' appreciation effect can be improved.

Optionally, during the formation of the privacy images, the transparent display device 21 is arranged in a position of the front windshield 10 higher than the height of seats in the vehicle. The formed privacy images can be located in an upper right part of the entire front windshield 10 so as to prevent the view of a passenger sitting in the rear portion of the vehicle being blocked by one sitting in front of him/her during the viewing and meanwhile to prevent a rear view mirror inside the vehicle body from blocking the passengers whey they view the images.

Besides, as another example, the display apparatus further comprises a light source part for providing light to the transparent display device 21, wherein the light source part is arranged on the vehicle body. Specifically, the light source part is arranged on the vehicle body and emits light to illuminate the transparent display device 21, thereby providing light to the transparent display device 21 such that the transparent display device 21 has sufficient light for image display. Specifically, the light source part is arranged in a position of the vehicle body where a wiper is located. The light source part can be a conventional incandescent lamp or an LED lamp, and any light source part that can provided light to the transparent display device 21 should be taken into consideration. An additional light source part enables the transparent display device 21 to clearly display images even during nighttime or on a cloudy day.

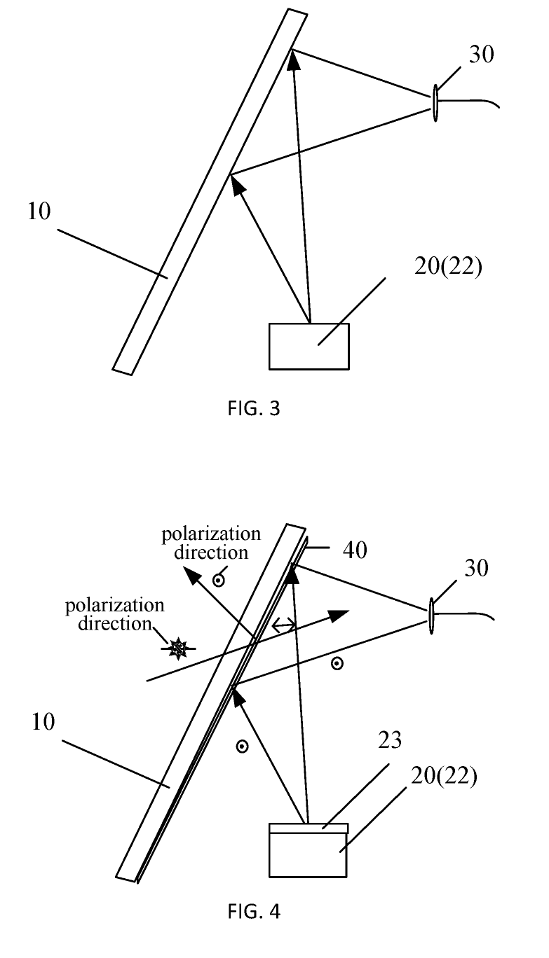

FIG. 3 is a schematic structural view of another display apparatus provided in an embodiment of this disclosure. As shown in FIG. 3, the transmitting device 20 is a projection device 22 arranged on the vehicle body which illuminates the front windshield 10 to form privacy images. The projection device 22 comprises a backlight source, a polarizer 211 arranged on the backlight source, and two substrates arranged on the polarizer 211 and aligned with each other, wherein a liquid crystal layer is arranged between the two substrates.

The transmitting device 20 provided in this embodiment generates images by projection. The transmitting device is arranged inside the vehicle body and light emitted thereby impinges on the front windshield 10 to form privacy images which can be viewed by passengers with the help of the polarized glasses 30 they wear. The transmitting device can be a projector, and a display portion of the projector comprises a backlight source, a polarizer 211 and two substrates aligned with each other. A liquid crystal layer is arranged between the two substrates, which makes it possible to form display images having a privacy protecting function.

A projection area of the projection device 22 is located in an upper middle part of the front windshield 10 such that the formed privacy images are located in the upper right part of the entire front windshield 10 and that the view of a passenger sitting in the rear portion of the vehicle will not be blocked by one sitting in front of him/her during the viewing. Meanwhile, this also prevents a rear view mirror inside the vehicle body from blocking the passengers whey they view the images.

As an optional embodiment, the projection device 22 is one capable of emitting polarized light, and the display apparatus further comprises a selectively reflective part 40 arranged on the front windshield 10 and capable of reflecting the polarized light emitted by the projection device 22. The selectively reflective part 40 can allow transmission of light having a different polarization direction than the polarized light emitted by the projection device 22. Specifically, as shown in FIG. 4 and FIG. 6, the selectively reflective part 40 provided in this embodiment can reflect polarized light emitted by the projection device 22 and allow transmission of light having a different polarization direction than the polarized light. As an example, the projection device 22 can be formed by arranging a polarizing plate 23 on a lens of a projection device in the prior art such that light emitted from the projection device 22 is polarized light, and the polarized light impinges on the selectively reflective part 40 and is reflected thereby. The passengers can wear polarized glasses for the viewing. Besides, among light from the outside of vehicle that illuminates the selectively reflective part 40, light having a same polarization direction as the polarized light emitted by the projection device 22 is reflected while polarized light having a different polarization direction is transmitted such that the displayed image cannot be viewed from the outside of the vehicle but the viewing of the inside through the window is not influenced.

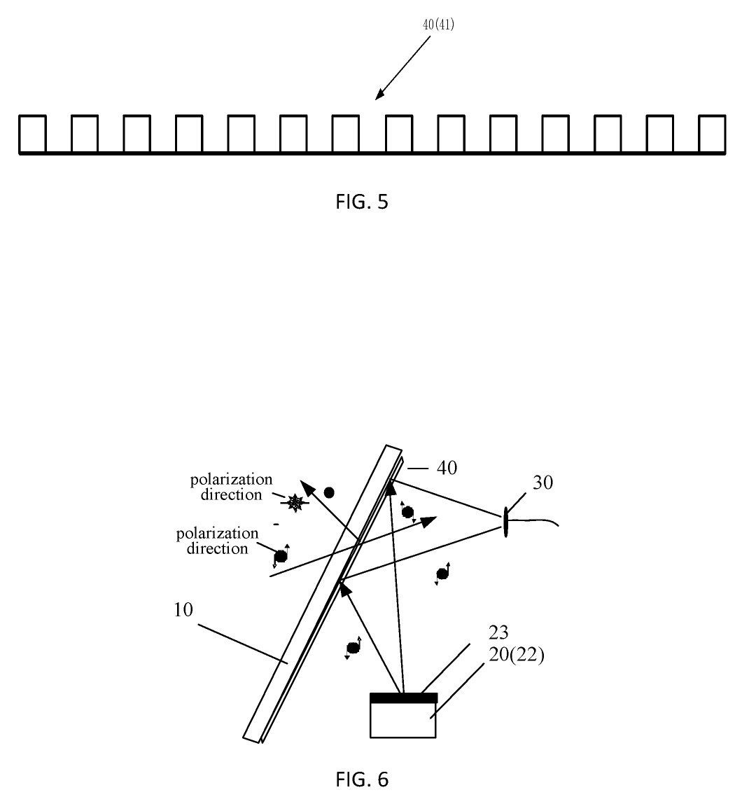

The selectively reflective part 40 can be a wire grid polarizing plate 41 or a cholesteric liquid crystal device 42. Specifically, as shown in FIG. 5, with a nano-scaled WLP (wire grid polarizing plate 41), a nano-scaled WLP plate can reflect polarized light vibrating along a direction of nano metal wires and allow transmission of polarized light perpendicular thereto. In this way, selective transmission of polarized light can be achieved and thereby function of the polarizing plate 23 can be achieved. The polarization principle is as follows: light is a kind of electromagnetic waves, in which an electric field and a magnetic field are propagated alternately, wherein the directions of the electric field and the magnetic field are perpendicular to each other. When the direction of the metal wires is parallel with that of electric vectors in the electromagnetic waves, light having an electric field parallel with the direction of the metal wires will cause vibration of electrons in the metal wires, and the electric vectors will excite a current in the metal wires, and thus energy of the light is converted into heat such that no electromagnetic waves pass through the polarizing plate 23. When the direction of the electric vectors is perpendicular to that of the metal wires, the electromagnetic waves cannot excite a current in the metal wires such that the electromagnetic waves can pass through the polarizing plate 23.

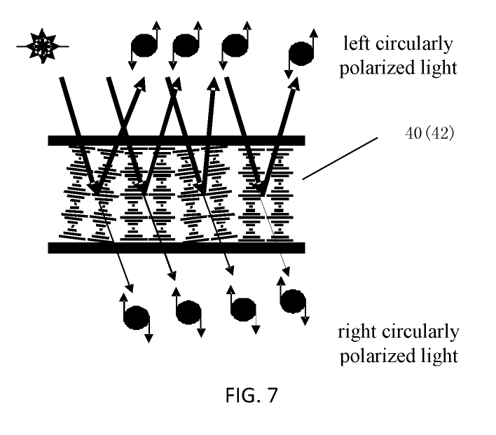

With a cholesteric liquid crystal device 42, as shown in FIG. 6 and FIG. 7, after natural light passes through left-handed liquid crystals, a portion thereof (left circularly polarized light) is reflected back and the other portion (right circularly polarized light) is transmitted, and thereby selective reflection of the circularly polarized light is achieved. In this case, for images projected on the windshield, they cannot be viewed by people outside the vehicle, but only by those inside the vehicle.

The embodiments of this disclosure further provide a vehicle, the vehicle comprising a vehicle body and any of the above display apparatus arranged on the vehicle body.

In the above embodiments, privacy images are formed on the front windshield 10 of the vehicle body by the transmitting device 20, such that the formed images will not interfere with the driver's driving. Meanwhile, the passengers can view the images on the front windshield 10 by wearing the polarized glasses 30. By using the above transmitting device 20 to form privacy images on the front windshield 10, an area of display is enlarged and the passengers' viewing is facilitated. Passengers sitting in the rear portion of the vehicle can clearly view the images, and the visual effect during the passengers' viewing is improved.

Obviously, those skilled in the art can make various modifications and variations to this disclosure without deviating from the spirits and scopes of this disclosure. Thus if these modifications and variations to this disclosure fall within the scopes of the claims of this disclosure and the equivalent techniques thereof, this disclosure is intended to include them too.

1. A display apparatus comprising:
a transmitting device configured for forming privacy images on a front windshield of a vehicle body; and
polarized glasses configured for viewing the privacy images.

2. The display apparatus according to claim 1, wherein the transmitting device is a transparent display device arranged on the front windshield, the transparent display device comprising a polarizer, two substrates arranged on the polarizer and aligned with each other, and a liquid crystal layer arranged between the two substrates.

3. The display apparatus according to claim 2, wherein the transparent display device is arranged in a position of the front windshield higher than the height of seats in the vehicle.

4. The display apparatus according to claim 2, further comprising a light source part for providing light to the transparent display device, wherein the light source part is arranged on the vehicle body.

5. The display apparatus according to claim 3, wherein the light source part is arranged in a position of the vehicle body where a wiper is located.

6. The display apparatus according to claim 1, wherein the transmitting device is a projection device arranged on the vehicle body, the projection device illuminating the front windshield to form privacy images; and wherein the projection device comprises a backlight source, a polarizer arranged on the backlight source, two substrates arranged on the polarizer and aligned with each other, and a liquid crystal layer arranged between the two substrates.

7. The display apparatus according to claim 6, wherein the projection device is one capable of emitting polarized light, and the display apparatus further comprises a selectively reflective part arranged on the front windshield and capable of reflecting the polarized light emitted by the projection device, and wherein the selectively reflective part can allow transmission of light having a different polarization direction than the polarized light emitted by the projection device.

8. The display apparatus according to claim 7, wherein the selectively reflective part is a wire grid polarizing plate or a cholesteric liquid crystal device.

9. The display apparatus according to claim 6, wherein a projection region of the projection device is located in an upper middle part of the front windshield.

10. A vehicle, comprising a vehicle body and the display apparatus according to claim 1 arranged on the vehicle body.

11. The vehicle according to claim 10, wherein the transmitting device is a transparent display device arranged on the front windshield, the transparent display device comprising a polarizer, two substrates arranged on the polarizer and aligned with each other, and a liquid crystal layer arranged between the two substrates.

12. The vehicle according to claim 11, wherein the transparent display device is arranged in a position of the front windshield higher than the height of seats in the vehicle.

13. The vehicle according to claim 11, further comprising a light source part for providing light to the transparent display device, wherein the light source part is arranged on the vehicle body.

14. The vehicle according to claim 12, wherein the light source part is arranged in a position of the vehicle body where a wiper is located.

15. The vehicle according to claim 10, wherein the transmitting device is a projection device arranged on the vehicle body, the projection device illuminating the front windshield to form privacy images; and wherein the projection device comprises a backlight source, a polarizer arranged on the backlight source, two substrates arranged on the polarizer and aligned with each other, and a liquid crystal layer arranged between the two substrates.

16. The vehicle according to claim 15, wherein the projection device is one capable of emitting polarized light, and the display apparatus further comprises a selectively reflective part arranged on the front windshield and capable of reflecting the polarized light emitted by the projection device, and wherein the selectively reflective part can allow transmission of light having a different polarization direction than the polarized light emitted by the projection device.

17. The vehicle according to claim 16, wherein the selectively reflective part is a wire grid polarizing plate or a cholesteric liquid crystal device.

18. The vehicle according to claim 15, wherein a projection region of the projection device is located in an upper middle part of the front windshield.
